(19) United States
(12) Patent Application Publication
(10) Pub. No.: US 2024/0237846 A1
(43) Pub. Date: Jul. 18, 2024

(54) COFFEE MAKER

(71) Applicant: HUGH Inc., Chuncheon-si (KR)

(72) Inventor: Hyunsoo KIM, Paju-si (KR)

(21) Appl. No.: 18/169,318

(22) Filed: Feb. 15, 2023

(30) Foreign Application Priority Data
Jan. 13, 2023 (KR) 10-2023-0005509

(51) Int. Cl. A47J 31/38; A47J 31/00; A47J 31/36

(52) U.S. Cl. CPC A47J 31/38; A47J 31/005; A47J 31/3671

(57) ABSTRACT

Disclosed herein is a coffee maker. In the coffee maker: a pair of rotatable levers extend on both sides of the coffee maker, and gears are formed at the top ends of the rotatable levers and engage with each other; curved heads are mounted on the upper portions of the rotatable levers, respectively; a pair of connecting rods extend downward from the opposite sides of the lower portions of the heads and are coupled to a movable part, the pair of connecting rods are inclined downward to converge toward the center, and the separation distance between the opposite side surfaces of the lower ends of the connecting rods is 1 cm or less; and each of the connecting rods includes a double bar in which a first connecting rod member and a second connecting rod member having the same structure are coupled to each other at a predetermined interval.

### CROSS-REFERENCE TO RELATED APPLICATION

This application claims the benefit of Korean Patent Application No. 10-2023-0005509 filed on Jan. 13, 2023, which is hereby incorporated by reference herein in its entirety.

### BACKGROUND

### 1. Technical Field

The present invention relates to an espresso coffee maker that is capable of manually extracting espresso without electricity. In particular, the present invention relates to a coffee maker that is robust, is simple to operate, and is capable of extracting coffee liquid by efficiently performing compression and generating high pressure.

The present invention relates to a portable lever-type espresso coffee maker that has higher extraction performance, usability, and durability by efficiently improving the mechanism thereof.

### 2. Description of the Related Art

As a method of extracting coffee using ground coffee, a method using an electric coffee machine is common.

However, since the coffee liquid is rapidly extracted using heated water, the flavor is degraded. Due to the use of a paper filter, the oil component of coffee is filtered out, thereby reducing the flavor of coffee, and a long time is taken to extract coffee.

The Dutch coffee extraction method is a method of extracting coffee liquid for a long time by using water of room temperature or cold water. In the case of this method, the structure of a coffee maker is complicated and there is an inconvenience of waiting for a long time.

In addition, lever-type espresso extractors have been currently commercialized. However, these machines are expensive, take up a lot of space, and are inconvenient to carry. In addition, a long preheating time is required, cleaning is inconvenient, and there is a concern that the machines may fall forward because one lever is used and thus force is concentrated forward when the lever is pressed.

Korean Patent Application Publication No. 10-2018-0029045 relates to a piston-type espresso coffee machine for coffee, and discloses a so-called “hold-to-operate” type machine, including a cylinder, a piston, a rod with an end cooperating with the piston, an actuating lever, and a drive member for moving the piston. However, this patent application technology is disadvantageous in that it is difficult to design and mount the piston and a spring pressed by the actuating lever and the mechanical structure of the machine is complicated.

Therefore, there is a need to provide a coffee maker that can generate higher pressure more easily by changing a lever mechanism, is portable due to its small size, can supply hot water using an external electric heater without the need for time required to boil water using a heating element, and does not require warm-up time.

As such a coffee maker, the present applicant proposed a coffee maker including a base 14′ installed on a transparent cylindrical housing, a driving mechanism 10′ installed to partially pass through the base 14,′ and a movable part 12′ connected to the driving mechanism 10,′ as shown in FIGS. 6A to 6B, through Korean Patent No. 10-2202040. The lower part of the moving part 12′ is composed of a compression part 132,′ and the lower surface of the housing is closed by a coffee extraction part 18,′ so that a space 16′ is formed between the compression part 132′ and the coffee extraction part 18′ and coffee powder or grain is placed on the coffee extraction part 18.′ High-temperature or room-temperature water is injected into the space 16′ through the top surface of the housing. The housing may be any receptacle or container capable of containing coffee powder or coffee liquid.

When a user presses and rotates the driving mechanism 10′ by hand, the movable part 12′ acts as a piston and gradually moves vertically downward (see FIG. 10b). Thereafter, when the driving mechanism 10′ is completely pressed and thus the compression part 132′ is brought adjacent to the coffee extraction part 18,′ the operation of extracting coffee liquid is completed (see FIG. 10c).

The present invention was conceived to further improve the preceding patent application technology of the present applicant.

### SUMMARY

Therefore, an object of the present invention is to provide a coffee maker that provides stronger power, is stable, and can improve coffee extraction performance.

In order to accomplish the above object, the present invention provides a coffee maker, wherein: a pair of rotatable levers extend on both sides of the coffee maker, and gears are formed at the top ends of the rotatable levers and engage with each other; curved heads are mounted on the upper portions of the rotatable levers, respectively; a pair of connecting rods extend downward from the opposite sides of the lower portions of the heads and are coupled to a movable part, the pair of connecting rods are inclined to converge toward the center of the coffee maker in a downward direction, and the separation distance between the opposite side surfaces of the lower ends of the connecting rods is 1 cm or less; and each of the connecting rods includes a double bar in which a first connecting rod member and a second connecting rod member having the same structure are coupled to each other at a predetermined interval.

The movable part may include a compression part configured to constitute a lower portion and a vertical part configured to be erected upright from the compression part, wear-resistant members may be mounted on both sides of the vertical part, and the wear-resistant members may be made of Teflon material, so that they can prevent abrasion with the inner wall of a housing constituting the appearance of the coffee maker during the vertical movement of the movable part and reduce frictional force to accurately guide the connecting rods and the movable part through the ascending and descending movement thereof.

Openings aligned with openings formed by the insides of rims of the gears may be formed in the upper portions of the heads, and bushes may be installed to pass through the two openings while coming into contact with the inner surfaces of the openings, so that the smooth rotation of the gears and heads can be maintained and the durability of the parts can be increased.

A cup coupling part configured such that a cup is coupled thereto may be included, a rim may be installed on the top of the cup coupling part, and a plurality of openings for high pressure discharge may be formed in the rim.

### BRIEF DESCRIPTION OF THE DRAWINGS

The above and other objects, features, and advantages of the present invention will be more clearly understood from the following detailed description taken in conjunction with the accompanying drawings, in which:

FIGS. 1A and 1B are drawings showing examples of the use of a coffee maker according to an embodiment of the present invention;

FIG. 2 is a perspective view of the coffee maker 1 of FIG. 1B cut in a vertical direction, which shows a final state in which levers are completely closed;

FIG. 3A is a front view showing the separated upper structure of the coffee maker including the connecting rods of the present invention;

FIG. 3B is a front perspective view showing the same structure;

FIG. 4 is an enlarged view of the upper portion of a head to illustrate the improvement of the present invention;

FIG. 5 is an enlarged view showing the periphery of a cup coupling part to illustrate the improvement of the present invention; and

FIGS. 6A and 6B are diagrams illustrating the structure and function of the coffee maker of the preceding patent application technology of the present applicant.

### DETAILED DESCRIPTION

Some embodiments of the present invention will be described in detail below with reference to exemplary drawings.

It should be noted that in the assignment of reference numerals to components of each drawing, the same components have the same numerals as much as possible even when they are illustrated on different drawings. Furthermore, in the description of the present embodiment, when it is determined that a detailed description of a related known configuration or function may obscure the gist of the present embodiment, the detailed description will be omitted.

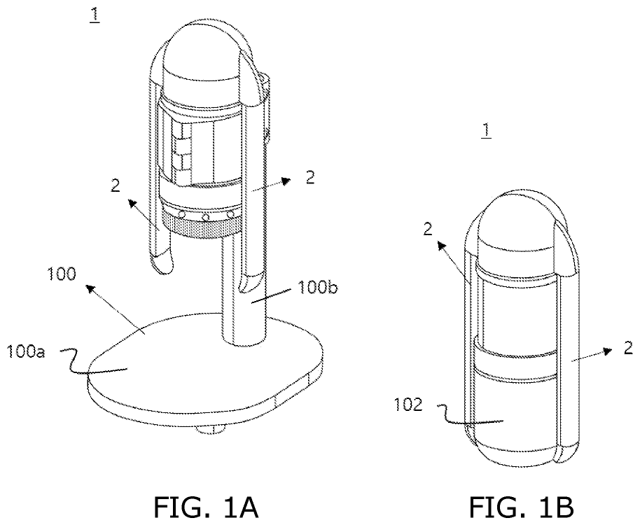

As shown in FIG. LA, a coffee maker 1 according to an embodiment of the present invention may be assembled and used onto a stand 100 including a base plate 100a and a support column 100b. Alternatively, as shown in FIG. 1B, a cup 102 may be mounted on the bottom of the coffee maker 1, and the coffee maker 1 may be used as a portable device in this case. The coffee maker 1 is fabricated as a round streamlined circular column. When levers 2 are closed to come into contact with a housing as shown in FIG. 1B from a spread state, coffee is extracted and collected in the cup 102. The levers 2 of the present invention are fabricated to have a thickness and a length that are about 3 mm longer and about 2 cm longer than those of the preceding patent application technology of the present applicant, respectively, so that the compression force can be further increased.

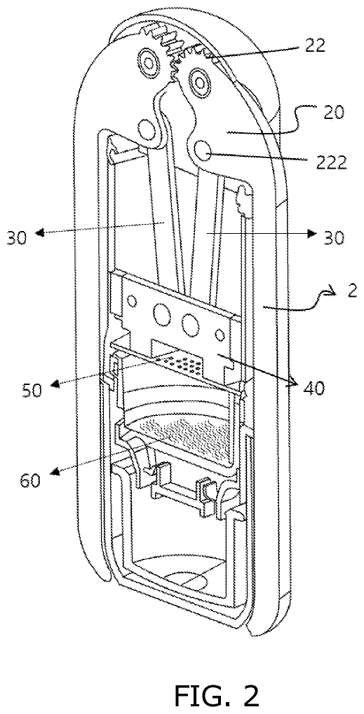

FIG. 2 is a perspective view of the coffee maker 1 of FIG. 1B cut in a vertical direction, which shows a final state in which the levers 2 are completely closed.

The pair of rotatable levers 2 are located on both sides of the coffee maker 1 over a long length. Gears 22 are formed at the top ends of the rotatable levers 2, and the gears 22 of the left and right levers 2 engage with each other.

A head 20 is a part covering the upper portion of each of the rotatable levers 2, and may be formed as a member separate from the lever 2 or integrated with the lever 2. The head 20 has a curved shape like a cam. A pair of connecting rods 30 extend downward from fixing parts 222 on first sides of the lower portions of the levers 2, and are coupled to a movable part 40. The connecting rods 30 are inclined to converge toward the center of the coffee maker 1 in a downward direction. The lower ends of the connecting rods 30 coupled to the movable part 40 are close to each other, as shown in the drawing. It is preferable that the separation distance between the opposite side surfaces of the lower portions of the connecting rods 30 is 1 cm or less. This is a further improvement compared to the large lateral separation distance between the lower ends in the preceding patent application technology of the present applicant. When the levers 2 are rotated downward, pressing force is concentrated on the center of the two connecting rods and transmitted to the movable part 40, so that a higher pressing force can be generated.

The movable part 40 is placed adjacent to a shower screen 50 in a completely downwardly moved state. A filter basket 60 is installed below the shower screen 50 by a predetermined height.

A space S is formed between a lid on the top of the coffee maker 1 and the shower screen 50. When the levers 2 are gripped with hands and rotated downward in a laterally spread state, the connecting rods 30 are moved downward in the space due to rotation attributable to engagement between the gears 22. As the bottom surface of the movable part 40 moving together moves gradually closer to the shower screen 50, the coffee raw material located between the two members is finely ground or compressed and is then mixed with supplied water to become an undiluted coffee solution, and the undiluted coffee solution is extracted into the cup 102 through the filter basket 60.

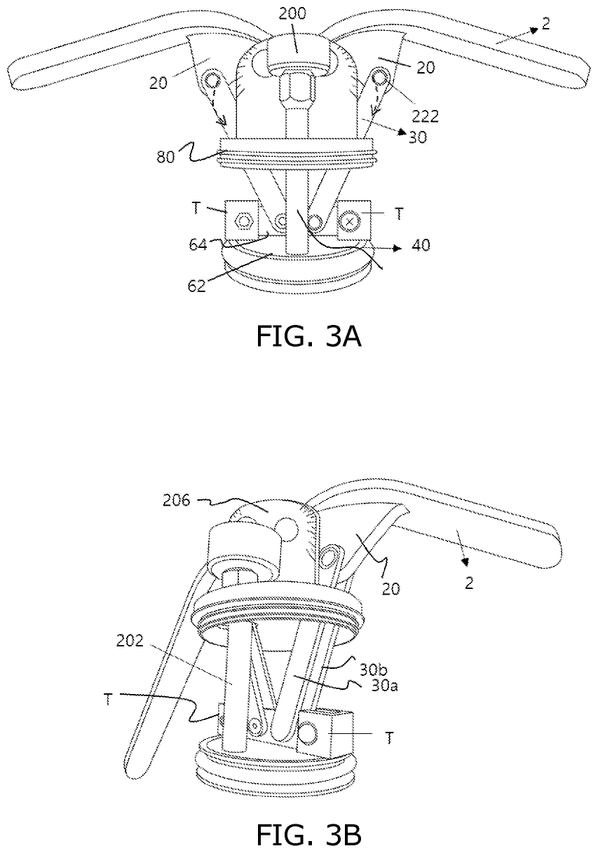

FIG. 3A is a front view showing the separated upper structure of the coffee maker 1 including the connecting rods 30 of the present invention, and FIG. 3B is a front perspective view showing the same structure before or immediately after the operation of the levers 2.

Unlike in FIG. 2, the fixing parts 222 of the heads 20 are raised to the right, and the connecting rods 30 are also moved upward. When the levers 2 are gradually pressed and closed, the fixing parts 222 of the heads 20 are rotated in the direction of the arrow, and the connecting rods 30 are linearly moved downward. The curved shape of the heads 20 functioning as cams is determined according to the optimal moving distance of the connecting rods 30.

Referring to the two drawings together, each of the connecting rods 30 is formed of a double bar in which a first connecting rod member 30a and a second connecting rod member 30b having the same structure are coupled to each other at a predetermined interval. The top ends of the first connecting rod member 30a and the second connecting rod member 30b are fixed to the front and rear surfaces of the head 20 with fastening members such as bolts, and the lower ends of the first connecting rod member 30a and the second connecting rod member 30b are fixed to the front and rear surfaces of the vertical part 64 of the movable part 40 with fastening members. This structure helps the connecting rods 30 to stably move downward without shaking while transmitting a stronger force, compared to the structure in which the connecting rod 30 is formed of a single column as in the prior patent technology of the present applicant.

The movable part 40 includes a circular compression part 62 configured to constitute a lower part and a vertical part 64 configured to be erected upright from the compression part 62. Wear-resistant members T are mounted on both sides of the vertical part 64. The wear-resistant members T may be made of, for example, Teflon material. Normally, the vertical part 64 is made of metal or rigid plastic material. Usually, the vertical part 64 is made of a metal or rigid plastic material. If both sides are made of Teflon material, abrasion against the inner wall of the housing is prevented during vertical movement, and at the same time, frictional force against the inner wall is reduced to accurately guide the ascending and descending movement of the connecting rods 30 and the movable part 4.

A cap coupling part 80 is a member that is rotationally coupled to the rim of the upper portion of the container of the coffee maker 1. The cap coupling part 80 maintains a fixed state that does not move in an annular shape.

Upper plates 206 having a curved top surface in a wide square plate shape are installed in the front and rear from the heads 20 to the cap coupling part 80, and are firmly coupled to the front and rear surfaces of the heads 20 with a bolt and nut on the opposite sides of the heads 20 to provide a platform.

In front of the upper plate 206, a pressure gauge extension part 200 is installed while passing through the cap coupling portion 80 at a predetermined interval therefrom. The end of the rod 202 of the extension part 200 comes into contact with the top surface of the compression part 62, and moves together when the moving part 40 moves up and down. The gauge extension part 200 also serves to support the movement of the moving part 40.

Next, other improvements of the coffee maker of the present invention will be described with reference to drawings showing each part in detail.

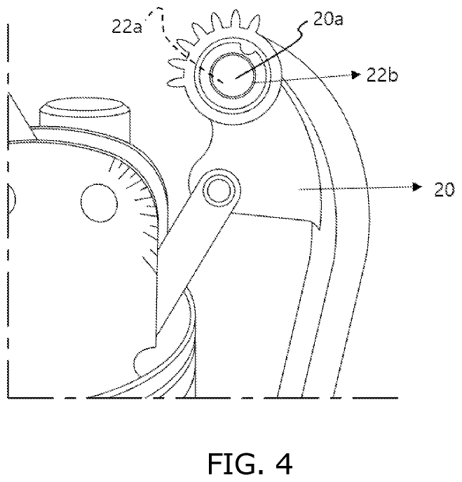

As shown in FIG. 4, the opening 20a of the upper portion of the head 20 is aligned with an opening 22a formed by the inside of the rim of the gear 22, and the two members are coupled by a fastening member (not shown). However, when the gears 22 are rotated due to the rotation of the levers 2, the fastening members rub against the inner surfaces of the opening 22a and opening 20a, making it difficult to move the levers 2 and abrading contact surfaces. In order to solve this problem, according to the present invention, Teflon-coated bushes 22b are installed to come into contact with the inner surfaces of the openings 20a and 22a and pass therethrough. Therefore, the smooth rotation of the gears 22 and the heads 20 can be ensured, and durability of the components can be increased.

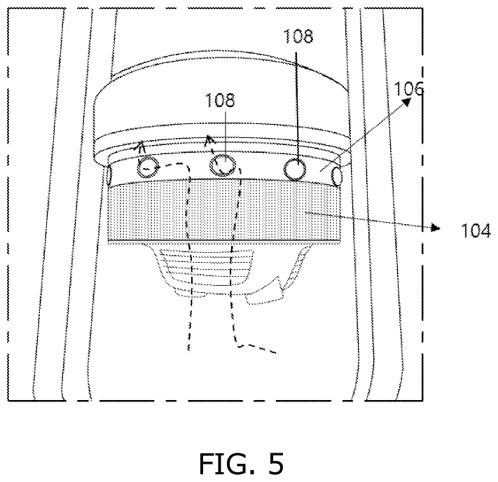

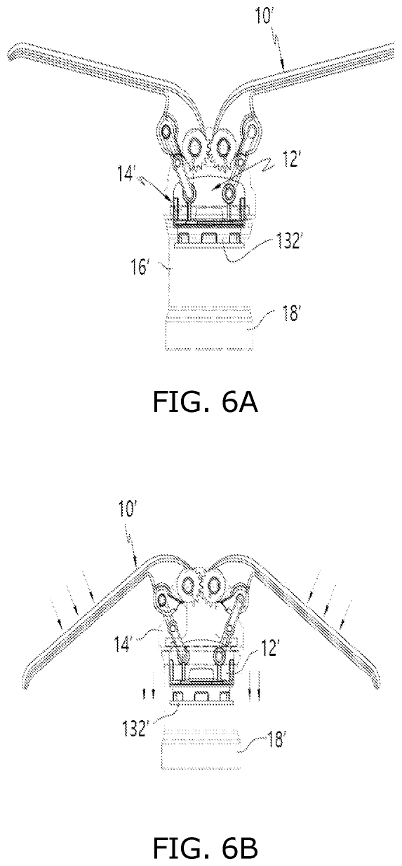

As shown in FIG. 5, in the present invention, the cup coupling part 104 to which the cup is coupled has a circular rim shape. Similarly, a rim 106 having a rim shape is installed on the upper portion of the cup coupling part 104. A rib is formed vertically on the outer surface of the cup coupling part 104 to support the inner surface of the cup. A plurality of openings 108 for high pressure discharge are formed in the rim 106. When the inner surface of the cup is closely attached to the outer surface of the cup coupling part 104 and thus sealing from the outside is substantially achieved, a high pressure is formed inside the cup, making it difficult to separate the cup. However, according to the present invention, the air inside the cup rises up through the outlet and is discharged to the outside through the opening 108 of the rim 106, so that vacuum can be prevented and friction can be reduced to facilitate the attachment and detachment of the cup.

Although one embodiment of the present invention has been described above, this is merely for illustrative purposes, and the size, shape, location, and number of each member may be variously changed without limiting the scope of the present invention.

All of these modifications also fall within the scope of the present invention, and the scope of the invention is defined by the appended claims below.

According to the present invention, the connecting rods of the drive mechanism of the coffee maker have a double bar structure and the distance between the opposing connecting rods is narrowed, so that a larger pressing force can be applied.

The coffee maker of the present invention is robust, has excellent durability, prevents scratches and abrasion between parts, and can be beautifully decorated with metal and transparent plastic materials.

What is claimed is:

1. A coffee maker, wherein:
a pair of rotatable levers extend on both sides of the coffee maker, and gears are formed at top ends of the rotatable levers and engage with each other;
curved heads are mounted on upper portions of the rotatable levers, respectively;
a pair of connecting rods extend downward from opposite sides of lower portions of the heads and are coupled to a movable part, the pair of connecting rods are inclined to converge toward a center of the coffee maker in a downward direction, and a separation distance between opposite side surfaces of lower ends of the connecting rods is 1 cm or less; and
each of the connecting rods includes a double bar in which a first connecting rod member and a second connecting rod member having a same structure are coupled to each other at a predetermined interval.

2. The coffee maker of claim 1, wherein the movable part includes a compression part configured to constitute a lower portion and a vertical part configured to be erected upright from the compression part, wear-resistant members are mounted on both sides of the vertical part, and the wear-resistant members are made of Teflon material, so that they can prevent abrasion with an inner wall of a housing constituting an appearance of the coffee maker during vertical movement of the movable part and reduce frictional force to accurately guide the connecting rods and the movable part through ascending and descending movement thereof.

3. The coffee maker of claim 2, wherein openings aligned with openings formed by insides of rims of the gears are formed in upper portions of the heads, and bushes are installed to pass through the two openings while coming into contact with inner surfaces of the openings, so that smooth rotation of the gears and heads is maintained and durability of the parts is increased.

4. The coffee maker of claim 3, wherein a cup coupling part configured such that a cup is coupled thereto is included, a rim is installed on a top of the cup coupling part, and a plurality of openings for high pressure discharge are formed in the rim.
